(19) United States
(12) Patent Application Publication
(10) Pub. No.: US 2026/0208950 A1
(43) Pub. Date: Jul. 23, 2026

(54) A DEVICE AND METHOD FOR INSERTING OF STORAGE CONTAINERS WITH TEMPERATURE-SENSITIVE GOODS INTO A TEMPERATURE CONTROLLED SECTION OF AN AUTOMATED STORAGE AND RETRIEVAL SYSTEM

(71) Applicant: AutoStore Technology AS, Nedre Vats (NO)

(72) Inventors: Ole Andreas Haddeland, Avaldsnes (NO); Audun Sagen, Oslo (NO); Øystein Gjerdevik, Skjold (NO); Amund Skålerud, Etne (NO); Joakim Aleksander Myrbakken, Skudeneshavn (NO)

(21) Appl. No.: 19/124,098

(22) PCT Filed: Oct. 26, 2023
(86) PCT No.: PCT/EP2023/079880

§ 371 Date: Apr. 24, 2025

(30) Foreign Application Priority Data
Oct. 28, 2022 (NO) 20221156
Dec. 23, 2022 (NO) 20221393

(51) Int. Cl. B65G 1/04; F25D 13/06

(52) U.S. Cl. CPC B65G 1/0485; B65G 1/0464; F25D 13/062

(57) ABSTRACT

A device for insertion of storage containers (106) carrying temperature-sensitive goods, into an automated storage and retrieval system and a method thereof is disclosed. The container insertion device is provided with a compartment with a passage (602), a temperature-controlled section (620) in the passage that contains a refrigeration equipment (621) for reducing the temperature of the storage container (106) or the goods stored in the container as required. A conveyor (603) transports storage container (106) through the passage (602). The passage (602) also comprises several temperature sensors (622), a label affixing device (604), an ID scanner (605), a camera. The device is also provided with a support or a platform (607) that extends from the exit of the passage into a storage column (105) of the automated storage and retrieval system to allow insertion of storage containers (106).

### FIELD OF THE INVENTION

The present invention relates to a device provided with a temperature controlled section to control the temperature of the storage containers and temperature-sensitive products contained therein, before they are inserted into the storage and retrieval system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c, 401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO 2014/090684A1 or WO 2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns are storage columns 105, i.e. columns 105 where storage containers 106 are stored in stacks 107. FIG. 5 shows the lowermost level of a number of storage columns, with containers 106 placed at the lowermost position, for example adjacent to the floor of the facility.

As can be seen in FIG. 5, a storage column 105 is defined by four upright members 102. Guide profiles 103 are arranged on the upright members 102 to retain the containers within the confines of the storage column 105 and to guide the container 106 as it is raised or lowered by a container handling vehicle. The guide profiles 103 are comprised of two faces 103a arranged at 90 degree and positioned to retain the corners of the container 106. As further shown in FIG. 5, the framework structure may be enclosed by walls 111, in this figure showing storage columns 105 adjacent to wall 111.

In addition to storage columns 105, there are columns in the framework that may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

### Insertion of Storage Containers into the System

An automated storage and retrieval 1 system often comprises several thousand storage containers 106. When initially constructed at a location, these several thousands of storage containers must be inserted into the system én mass. Likewise, if an existing system is expanded, many additional containers will need to be inserted into the system in a large operation. As can be appreciated, such mass insertion of storage containers, alternately referred to as “bins” is difficult and time consuming.

Currently, each of these storage containers is manually inserted through port columns 119, 120 of the automated storage and retrieval system, from which they are picked up by the container handling vehicles 201, 301 401 and transported to their storage locations within the framework structure.

Since manual container insertion operation requires a substantial amount of time, the access station or stations being used for container/bin insertion will be occupied and cannot be used for their intended purpose.

Hence, there is a need for an automated insertion solution, that is less cumbersome for inserting storage containers and avoids occupying the access station such that access stations would be free to perform their regular operations.

### Temperature Controlled Section of the Storage System

Automated storage and retrieval systems are increasingly being employed for storing goods that are temperature sensitive. One such area of application is cold storage of temperature sensitive goods. In cold storage, the temperature inside the automated storage and retrieval system is regulated to maintain the goods stored in the system as per their requirement. For example, there may be some areas in the automated storage and retrieval system wherein goods are stored at temperatures in the range of 0 to 4 degrees, for example, goods such as food products are chilled. Whereas in other areas, the goods may be stored at much lower temperatures in the range of minus 18 degrees where they need to be frozen.

When such temperature sensitive goods are to be introduced into the automated storage and retrieval system, they are manually placed in storage containers that are already in operation within the system and restocked into the system through the access stations. This presents several challenges as restocking must be performed manually by personnel, which occupies the access stations making them unavailable for fulfilling orders. In addition, the goods must be maintained at proper temperature prior to restocking.

This in turn adds to the costs, as any goods thawed or warmed while awaiting restocking may have to be discarded. The system as a result is in need of a more efficient means of restocking temperature-controlled goods, such as food products.

Therefore, there is a need for a device and a method for automating the stocking and/or restocking of temperature sensitive goods into a temperature-controlled section of an automated storage and retrieval system.

### SUMMARY OF THE INVENTION

The invention relates to a temperature-controlled storage container insertion device and a method for stocking or restocking temperature sensitive goods into a temperature controlled section of an automated storage and retrieval system. According to the invention, the device is arranged for automatically inserting storage containers filled with temperature-sensitive goods into an automated storage and retrieval system for eventual storage in a temperature-controlled section of the system. The invention further relates to a device that chills or freezes goods in the containers in connection with the insertion operation.

According an aspect of the invention, the goods are stocked/restocked into the storage and retrieval system by the containers containing the goods being “inserted” into the storage and retrieval system. As used herein, the term “inserting” a storage container or “bin” into an automated storage and retrieval system is meant as a term of art, comprising the steps of affixing an identification label comprising a machine-readable identification code to a new container and registering the container into the control system for the facility. The physical dimensions of the container are scanned or otherwise measured to ensure that the size of the container is within predefined tolerances. The goods may further be registered into a warehouse management system that tracks the inventory of goods within the automated storage and retrieval system.

In an aspect of the invention, the container insertion device of the invention is arranged to insert container laterally into an empty storage column of the system rather than via an access station. This, according to this aspect of the invention, the automated storage and retrieval system is provided with a lateral opening, door or cut-out in a wall enclosing the framework structure of the storage and retrieval system, at or near the floor of the facility in which the automatic storage and retrieval system is installed. The opening provides access to a storage column arranged at the periphery of the framework structure, adjacent to the wall. In the event no wall encloses the framework structure, there will be a plurality of storage columns exposed at the periphery of the framework structure.

The storage container insertion device of the invention (hereafter referred to as the “container insertion device” or “insertion device”) may be transported to this opening, for example by rolling on wheels, allowing containers to be inserted into the automated storage and retrieval system via the exposed storage column, rather than occupying a port column at an access station for the temporary purpose of container insertion. This allows container insertion to be performed while the automatic storage and retrieval system is in operation, without occupying an access station.

In an aspect of the invention, the insertion device comprises a conveyor for transporting containers to be inserted from a rear part of the device to a forward part of the device. As the container is transported along the conveyor, it encounters temperature controlled section and one or more automated container-preparation devices for performing tasks related to preparing a container for insertion into the system, for example one or more temperature sensors, a label attaching device, a scanner, a camera, and/or other devices to measure the dimensions of the container. In one aspect the container-preparation devices are mounted in or on a compartment having a through-going passage with an entry and an exit provided with doors through which the conveyor transports the containers, however such devices could be suspended above within the compartment or on the sides of the conveyor by a support or other means.

According to one aspect, the compartment of the device comprises a temperature controlled section that is provided with refrigeration equipment for controlling the temperature and chilling or freezing the temperature-sensitive goods stored in a storage container that passes through the compartment. The refrigeration equipment can be a blast chiller, a freezer unit or any other appropriate refrigeration equipment known in the art. The compartment is provided with an entrance door and an exit door to provide a temperature controlled environment within the compartment that may be required to achieve the right temperature for the temperature-sensitive goods stored in the container.

The insertion device is further provided with a support or a platform that extends outwards from the device and is arranged to be inserted laterally into the storage column exposed by the opening in the wall. The lateral dimensions of the platform is essentially the same as the lateral dimensions of a storage container, allowing the container to rest on the platform inside the storage column. In use, a storage container will be transported by the conveyor through the insertion device, encounter the temperature controlled section and various automated container-preparation devices, be transported to rest on the support or platform inside the storage column, where the container will await retrieval by a container handling vehicle that lowers its gripping device into the storage column. The storage containers with temperature-sensitive goods are then placed in a temperature controlled section of the automated storage and retrieval system. As can be appreciated, the insertion operation thus will greatly mitigate interference with the through-put of the system which would occur if one or more of the few access stations were diverted from their ordinary function to the task of container insertion. Once the container insertion operation is completed, the device may be removed, and the storage column made available for the normal storage of containers.

As described above in the background section, the storage columns of prior art automated storage and retrieval systems are defined by four upright members. These upright members often comprise guide profiles that help retain the corners of the containers within the confines of the storage column. Such guide profiles would therefore prevent storage containers or the platform of the insertion device from being inserted laterally into the storage column. Therefore, another aspect of the invention provides means to insert the containers laterally into the storage column.

In one aspect, the means to laterally insert the storage container may be to provide lateral openings in the guide profiles of the two upright members adjacent the opening in the wall. For example, a portion of the faces of the guide profiles that lie between the opening in the wall and the storage column may be cut away in a height at least as high as the containers. The platform of the insertion device and the containers can thus be inserted into the storage column though this lateral opening in the guide profile. An alternative solution would be to provide a movable segment of the faces of the guide profiles that lie between the opening in the wall and the storage column, whereby the movable segment may be pushed aside allowing a container to be inserted laterally. Examples of such a movable segment include a slidable segment that may be slid up or down or a hinged segment that may be pushed in or pulled out. In one example, the moveable segment can comprise hinged segments that are spring loaded, such that when the platform of the insertion device is inserted into the storage column, the platform pushes the segments inward against the force of a spring allowing the platform and containers to enter the storage column laterally. When the platform is removed, the spring will snap the segments back into place, where they can resume their guide profile function.

A storage container containing temperature-sensitive goods to be inserted into a temperature controlled section of the automated storage and retrieval system is carried by the conveyor which transfers the storage container towards an entrance door of a passage of the compartment of the device. At the compartment, the storage container with temperature-sensitive goods passes through temperature controlled section containing refrigeration equipment and various container-preparation devices prepare the container for insertion into the automated storage and retrieval system. For example, a labelling device affixes a label/identification tag to the storage container. The label is scanned by the scanner or otherwise recorded, and the information related to the container entered in the control system of the storage and retrieval system. A scanner or other device measures the dimensions of the containers to ensure that the container is in accordance with predefined size limits. The device may also comprise a camera to record images of the storage container. A machine-readable label identifying the contents of the container may also be affixed to the container. The scanning device can scan this label and record the contents with the warehouse management system.

As described above, the container and the contents are likewise transported through the temperature-controlled section, where the contents are chilled or frozen to a predetermined temperature dependent upon the nature of the goods. The control system of the storge system may communicate temperature information to the refrigeration equipment. In an aspect, the control system may control the opening and closing of the entrance and exit doors leading to the compartment, this ensures the goods within the container have attained the predetermined temperature.

Once the container has encountered the various container-preparation devices and has been confirmed ready to be inserted into the storage system and the goods have been chilled or frozen to the desired temperature, the storage container is passed by the conveyor to rest on the support or platform within the storage column. In one aspect, the goods may be chilled to temperature lower than the intended storage temperature to account for the any warming of the contents due to the travel time from the insertion device to the final destination.

A container handling vehicle is then instructed by the control system that the storage container is ready to be picked up from the storage column.

According to one aspect, the invention concerns a container insertion device for inserting storage containers into an automated storage and retrieval system laterally through a storage column of the system, the device comprising:
a compartment that has an entrance and an exit, and a passage for conveying storage containers between the entrance and the exit, wherein the compartment comprises a temperature controlled section comprising refrigeration equipment for reducing the temperature of the container and/or contents of the container,
a conveyor arranged for transporting storage containers through the passage from a rear part of the insertion device to a forward part of the container insertion device,
a support extending from the exit of the compartment, the support being arranged to receive and support a storage container, wherein the support is dimensioned for lateral insertion into the storage column and thereby support a storage container within the storage column for retrieval by a container-handling vehicle of the system, and
one or more of a label affixing device for affixing an identification label to a container, an ID scanning device for scanning an identification label, and a dimension scanning device arranged to measure the physical dimensions of the container, the one or more of said devices being in electronic communication with a control system of the storage and retrieval system.

According to another aspect, the invention concerns an automated storage and retrieval system, comprising a framework structure forming a storage grid, the framework structure comprising:
a rail system arranged at an upper level of the framework structure, the rail system comprising a first set of parallel rails arranged in a horizontal plane (P) and extending in a first direction (X), and a second set of parallel rails arranged in the horizontal plane (P) and extending in a second direction (Y) which is orthogonal to the first direction (X), which first and second sets of rails form a grid pattern in the horizontal plane (P) comprising a plurality of adjacent grid cells, and the storage grid defining a plurality of columns for use as storage columns, each storage column being arranged to store a respective stack of storage containers, wherein the storage columns are located beneath the rail system and wherein each storage column is located vertically below a respective grid cell;
a plurality of container handling vehicles that operate on the rail system for storing and retrieving storage containers to and from storage columns,
a control system configured for interacting with the system components and sending operating instructions to the plurality of container handling vehicles and other system components, the automated storage and retrieval system comprising:
an lateral opening in a side of the framework structure of the automated storage and retrieval system sized to allow a storage container to be inserted into a column of the system; and
   a device for inserting storage containers through the lateral opening into the storage columns for subsequent retrieval by container handling vehicles.

According to another aspect, the invention concerns a method for inserting storage containers containing temperature-sensitive goods into a temperature-controlled section of an automated storage and retrieval system, the method comprising the steps of:
providing an opening in a side of the automated storage and retrieval system, the opening being dimensioned to permit the lateral insertion of a storage container into a column within a framework structure of the automated storage and retrieval system,
providing a container insertion device as described above,
inserting the support of the insertion device through the opening to the column such that the support extends into the column,
placing a storage container containing temperature-sensitive goods on the conveyor,
operating the refrigeration equipment to establish a desired temperature within temperature-controlled section, the temperature based upon the nature of the goods within the container,
using the conveyor and transporting the storage container through the passage and through temperature controlled section towards the exit of the compartment of the device, the container remaining within temperature controlled section for a sufficient amount of time for the goods to achieve or maintain a desired temperature,
affixing an identification label to the storage container,
communicating identification information contained in the label and the nature of goods to a control system,
measuring the physical dimensions of the storage container using a dimension scanning device, and comparing the dimensions with predefined measurement tolerances,
using the conveyer to transport the storage container though the passage towards the exit of the compartment, and cooling the container and/or its contents as the container passes through the compartment,
using the conveyer to transport the container onto the support within the storage column, and
   using a container handling vehicle of the automated storage and retrieval system to pick up the storage container from the support within the column, and place the container in a temperature controlled section of the storage system.

According to another aspect, the invention concerns a computer program product for performing the method, wherein the product comprises:
a controller in communication with the control system and configured to monitor the if the temperature of the storage container has reached the target temperature as the container passes through the refrigerated equipment of the container insertion device;
a memory unit with a database for storing the monitored temperature of the storage container,
the controller sending instructions to the control system that the storage container has attained the target temperature,
the control system sending instructions to a container handling vehicle to pick up the storage container from a support within the column, and place the container in a temperature controlled section of the storage system.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a storage column, showing upright members with guide profiles.

FIG. 6 is a perspective view of an automated storage and retrieval system with an opening in a lower part of a wall enclosing the framework structure, exposing a storage column.

FIG. 7 depicts an embodiment of a container insertion device rolled adjacent the opening in wall enclosing the framework structure from FIG. 6.

FIG. 8 is a perspective cut-away view of an embodiment of a container insertion device.

FIG. 9 illustrates a storage container being checked for dimensions and scanned by a scanner before insertion into the storage column of the automated storage and retrieval system.

FIG. 10 depicts a storage container resting on an exit platform of the device and positioned in a storage column.

FIG. 11 illustrates the storage container resting on the exit platform of the container insertion device within the storage column, awaiting to be picked up by a container handling vehicle of the storage system.

FIGS. 12A and 12 B illustrate an empty storage column adjacent the opening in the wall from FIG. 6, showing different embodiments of an opening in the guide profiles permitting lateral insertion of a container into the storage column. FIG. 12A shows segments of faces of the guide profiles removed, while FIG. 12B show hinged segments of faces of the guide profiles.

FIG. 13 illustrates a storage container being handled by a temperature-controlled section of a container insertion device of the automated storage and retrieval system.

FIG. 14 illustrates a temperature controlled section of an automated storage and retrieval system.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

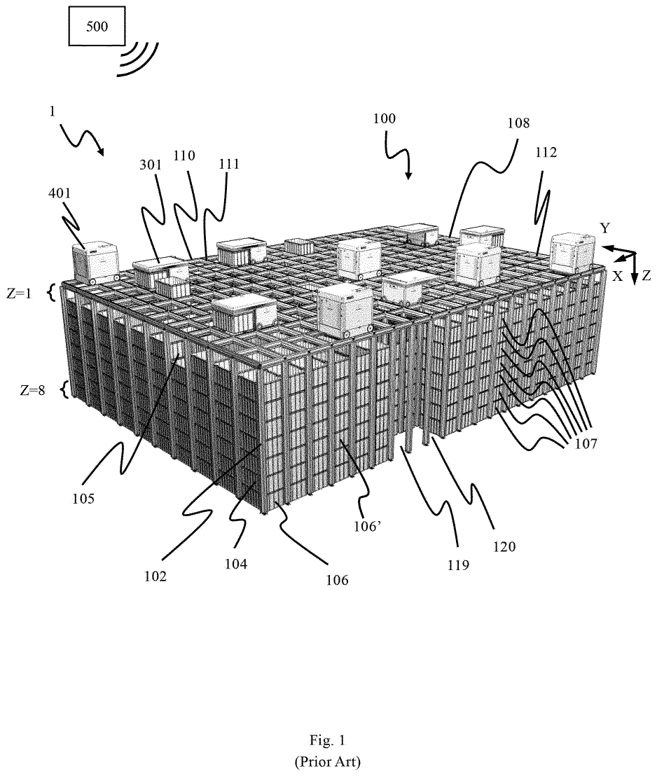

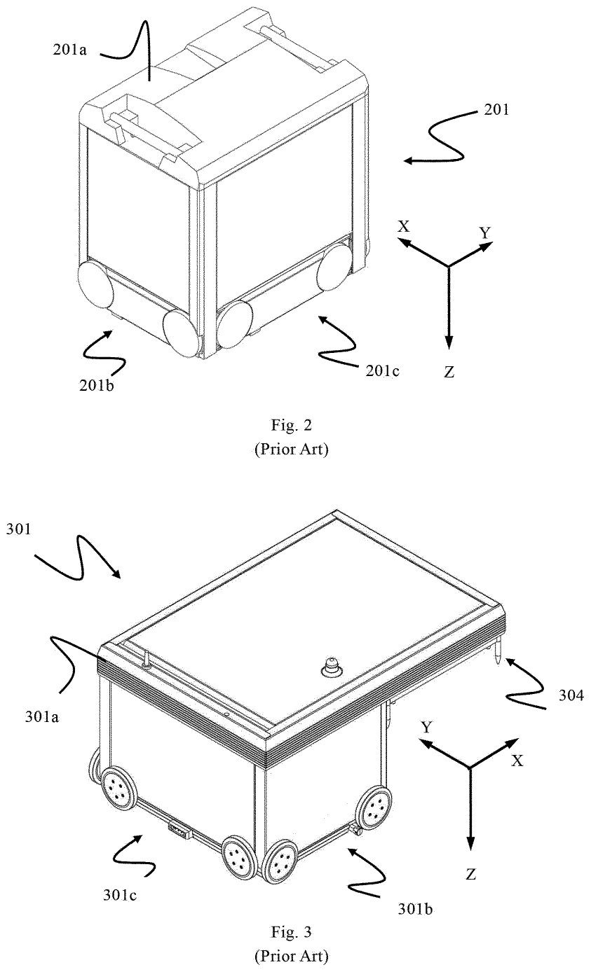

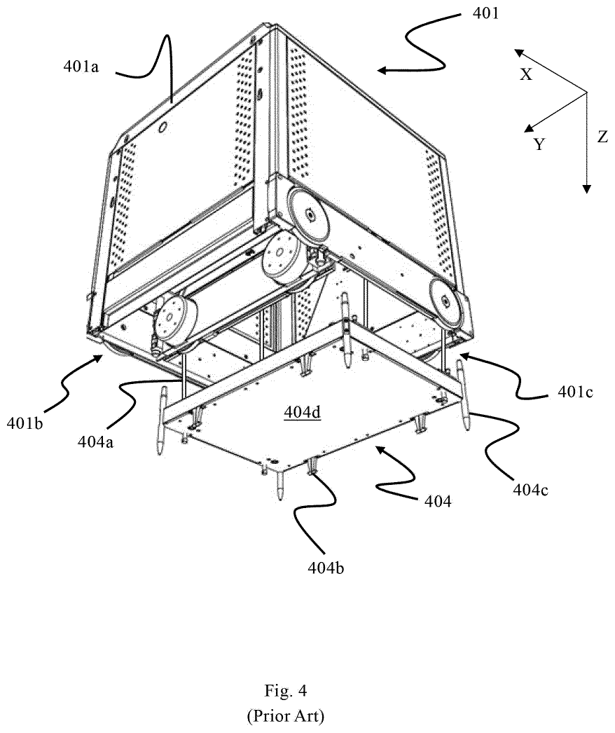

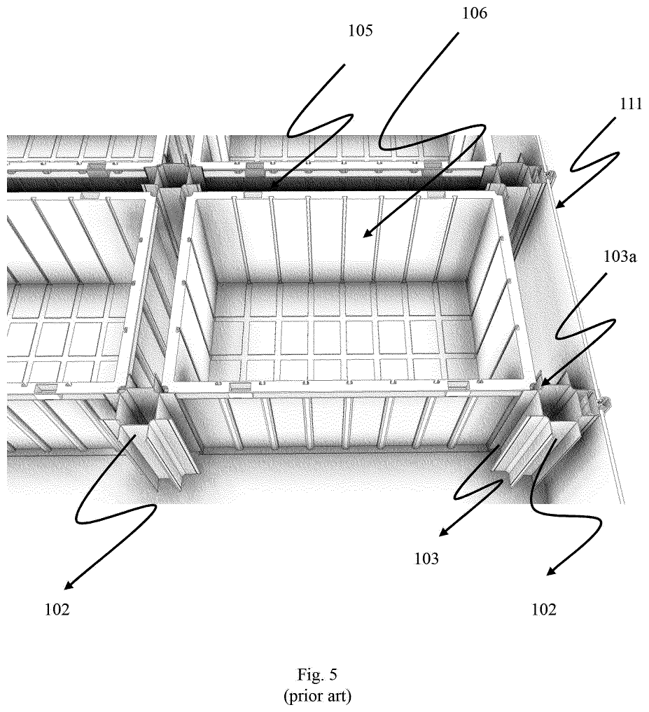

The framework structure 100 of the automated storage and retrieval system 1 is constructed in a similar manner to the prior art framework structure 100 described above in connection with FIGS. 1-5. That is, the framework structure 100, surrounded by a wall 111, comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

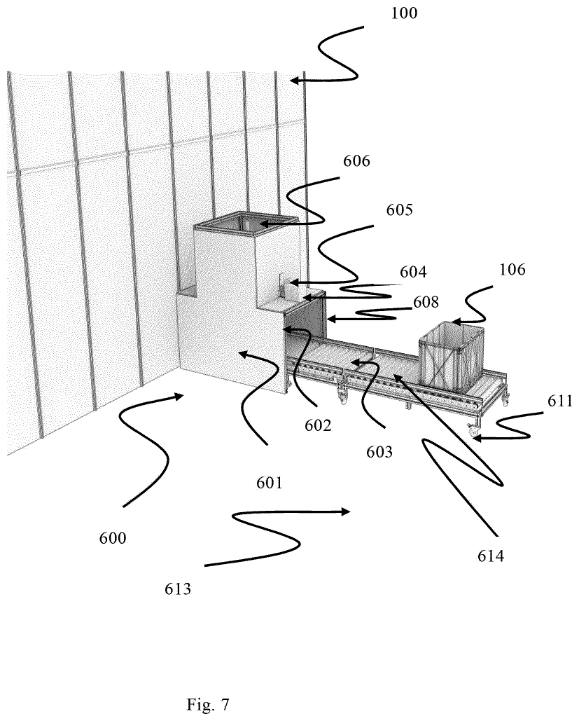

Aspects of a device and method for inserting storage containers with temperature-sensitive goods into the automated storage and retrieval system according to the invention will now be discussed in more detail with reference to FIGS. 6-14.

Throughout the description, storage containers 106 may be alternately referred to as bins. Further, container insertion device, bin insertion device and insertion device may be used interchangeably. The support and platform 607 may also be used interchangeably.

FIG. 6 is a perspective view of an automated storage and retrieval system 1. The framework structure of the automated storage and retrieval system is enclosed by walls 111. While FIG. 6 depicts a wall 111, it should be understood that an automated storage and retrieval system may comprise a framework structure that is not enclosed by a wall. According to one aspect of the invention, an opening 501 is formed in the wall 111, in order to expose a storage column 105. Obviously an opening 501 is not required if no wall surrounds the framework. Opening 501 provides lateral access to the storage column 105 of the framework structure adjacent to the wall, preferably at or near the lowermost level of the storage column 105. FIG. 6 illustrates a single opening 501, however it should be understood that according to the invention a plurality of openings 501 may be provided. The storage column 105 exposed by opening 501 is preferably devoid of containers. Opening 501 may be a simple opening as depicted or may be have a door or panel that may be selectively opened or closed.

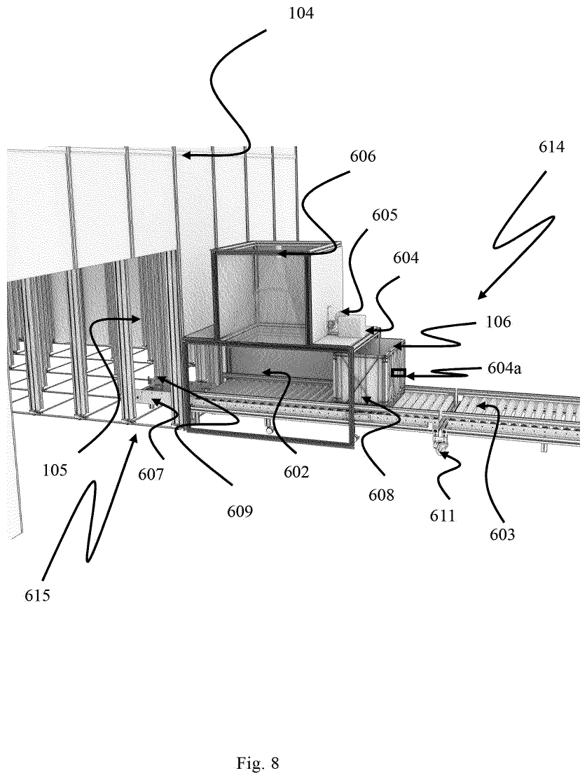

FIG. 7 depicts an embodiment of a container insertion device 600 of the invention positioned adjacent to (and concealing) the opening 501 in the wall 111 from FIG. 6. According to one aspect, container insertion device 600 is a portable device. According to one aspect container insertion device 600 comprises wheels 611, allowing the container insertion device to be rolled along a floor 613 of a facility in which the automated storage and retrieval system is installed to the opening 501.

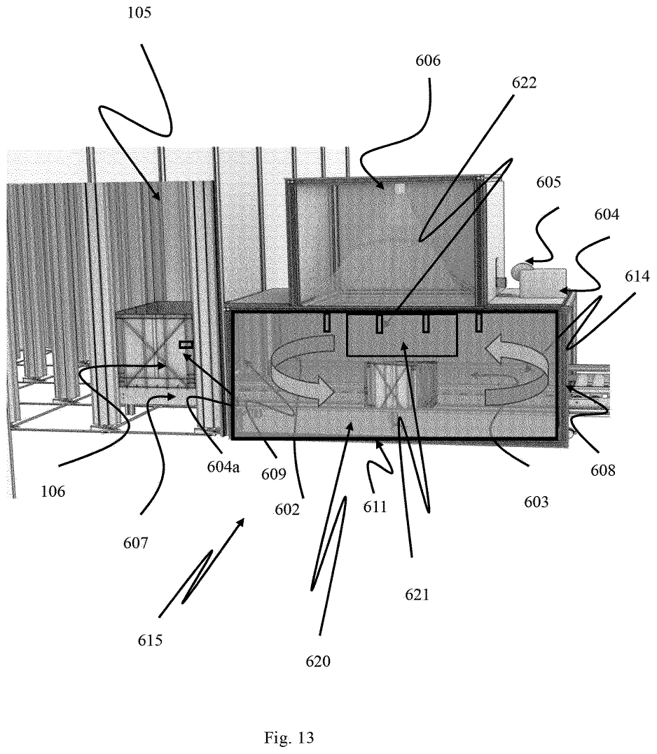

Container insertion device 600 comprises a conveyor 603 arranged to transport containers 106 to be inserted into the storage and retrieval system from a rear part 614 of the insertion device to a forward part 615 of the insertion device. The device comprises a compartment 601 having a through-going passage 602. Throughgoing passage 602 has an entrance 608 and an exit 609. The entrance 608 and exit 609 may be provided with doors to help regulate the temperature in the passage 602. Alternatively, the entrance 608 and exit 609 may comprise an air curtain. The passage 602 further comprises a temperature-controlled section with a refrigeration equipment 621 the details of which will be discussed in FIG. 13.

The conveyor 603 in this embodiment is arranged for transporting storage containers 106 longitudinally through passage 602. Conveyor 603 is preferably an automated conveyor belt, controlled by control system 500 of the automated storage and retrieval system.

Container insertion device 600 further comprises the passage containing temperature controlled section with refrigeration equipment and one or more container-preparation devices for automatically performing functions required to prepare a container for insertion into a temperature controlled section of the storage and retrieval system. Examples of such container-preparation devices include a labelling device 604 arranged to automatically affix a label 604a to the container. The label, which may comprise a QR code or other machine-readable code, comprises identification information for the container. In one aspect, the labelling device 604 automatically transmits the information regarding the label to the control system 500 of the storage and retrieval system. In addition, or alternatively, the insertion device 600 may comprise an ID scanner 605 arranged to scan a label 604a and transmit the identification information for the container to control system 500. Such an ID scanner may scan the label 604a affixed by labeling device 604 or could be used in the situation where containers have pre-affixed identification labels. The container-preparation devices may further include a dimension scanning device 606, such as a camera, laser scanner or other such device for measuring the dimensions of the container. Scanning device 606 is used to measure the physical dimensions of the container in order to confirm that the size of the container is within predefined tolerances prior to insertion. Additionally, the container preparation device may also include several temperature sensors configured to monitor the temperature of the storage container and the goods in the container and the passage or compartment as the containers pass through them. In one embodiment, the container-preparation devices are mounted in or on compartment 601 as illustrated, however it should be understood that such devices could be supported above or to the sides of the conveyor 603 by other means.

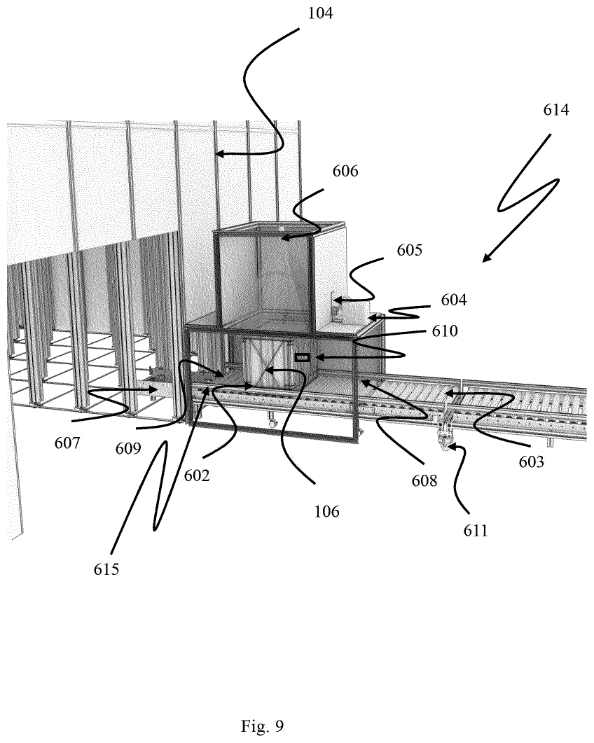

As shown in FIGS. 8-11, container insertion device 600 further comprises an exit platform or support 607 protruding longitudinally beyond the forward part 615 of the device, for example beyond exit 609 of the compartment 601. Platform 607 is dimensioned to be inserted into storage column 105 and to provide a resting place/support for containers 106 exiting the forward part 615 of the device/compartment 601 and awaiting retrieval by a container handling vehicle of the system. Platform or support 607 is illustrated as a platform having a flat surface, however one skilled in the art would understand that the term platform in this context would encompass other structures that perform the same function, such as support rails and the like.

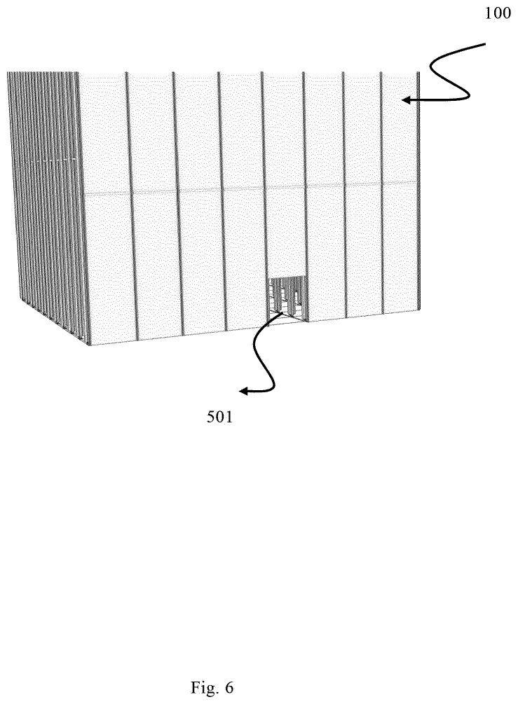

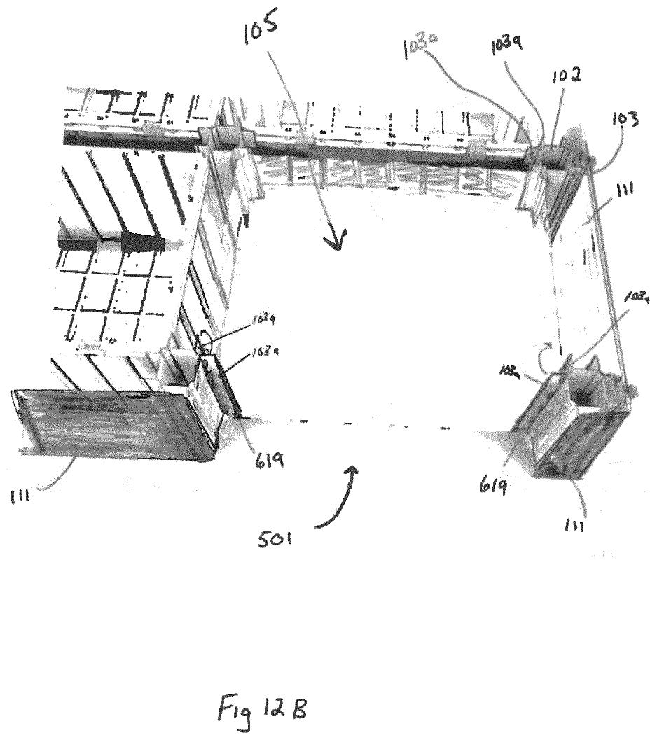

As shown in FIG. 5, a storage column in an automated storage and retrieval system is typically defined by four upright members comprising corner guide profiles 103. Such guide profiles retain the storage containers with the confines of the storage column but would thereby prevent lateral insertion of the exit platform 607 of the insertion device and/or the lateral insertion of storage containers by the device. Consequently, according to an aspect of the invention, a lateral opening 617 is formed in the guide profiles to permit such lateral insertion. In one embodiment shown in FIG. 12A, lateral opening 617 in the guide profile comprises removing a segment of guide profile faces 103a on the guide profiles located between opening 501 and storage column 105. In an embodiment shown in FIG. 12B, lateral opening 617 in the guide profile comprises a hinged segment 619 in guide profile faces 103a. Hinged segments are arranged to be pushed aside by platform 607 and/or containers 106, thus permitting lateral access to the storage column. In one aspect, hinged segment 619 may be spring loaded, such that it snaps back into place when platform 607 is removed.

Referring to FIGS. 6-14, the sequence of steps in a method of inserting a temperature-controlled storage container with temperature-sensitive goods into a temperature-controlled section of the storage and retrieval system using the device of the invention will be explained.

First, an opening 501 is provided in a wall 111 surrounding the framework of an automated storage and retrieval system, in the event there is such a wall, exposing a storage column 105.

Storage column 105 is modified to permit the lateral insertion of storage containers, by providing a lateral opening 617 as shown in FIGS. 12A and/or 12B.

A container insertion device 600 as described above is transported to opening 501, for example by being wheeled along the floor of the facility and placed adjacent the opening, with the support or platform 607 of the device being inserted into the exposed storage column 105.

As shown in FIG. 7, a storage container 106 with temperature sensitive goods that is to be inserted into the storage column 106 of the automated storage and retrieval system is placed on the conveyor 603 towards the rear part 614 of the container insertion device. The storage container 106 is then transported by the conveyor 603 towards the compartment 601 containing temperature-controlled section with refrigeration equipment towards the support or platform of the device. In an aspect, the conveyor 603 is configured to transport several storage containers 106 one after another.

FIG. 8 illustrates the preparation of a storage container to be inserted into the storage column 106 of the automated storage and retrieval system. In the example embodiment, the storage container 106 may be filled with temperature-sensitive goods, for example food products that may be chilled products or frozen products. The information on the food products loaded onto the storage containers is sent to the control system 500 or a warehouse management system, for example by a scanner reading a machine readable label affixed to the container. The filled storage container passes through an entrance door of the compartment 602 that comprises a passage 602 with container preparation devices. However, the container preparation device may also be mounted at a top level on a support that extends through the passage 602 of the compartment.

The container preparation devices thereupon perform various automatic tasks in order to prepare the container for insertion into the storage and retrieval system. For example, a labelling device 604 may affix an identification tag or a label 604a to the storage container 106 as shown in FIG. 8. The identification tag may also be a barcode, QR code, engraving or other forms of machine-readable information.

Identifying information for the container along with the information on the goods stored in the container is transmitted to the control system 500 of the storage and retrieval system. Such information may be transmitted by the label affixing device 604, or by a scanning device 605 may scan the label and transmit the identification information. Scanning device 605 would perform the same function in the event the containers are prelabeled.

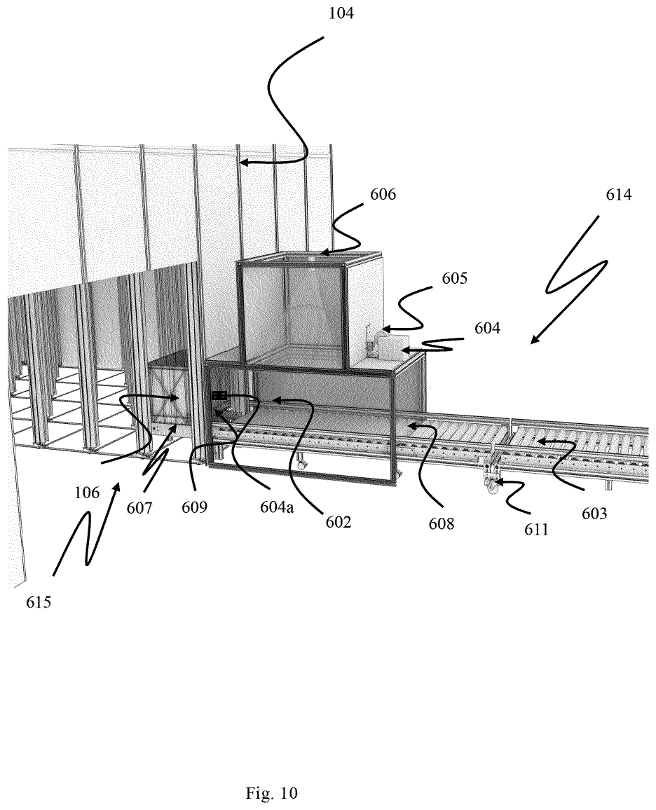

FIG. 9 illustrates the storage container being checked for dimensions and scanned by a dimension scanning device 606 before insertion into the storage column of the automated storage and retrieval system. Dimension scanning device 606 may be a cameral or other type of scanner such as a laser scanning device. The measured dimension is compared to predefined tolerances. If the dimensions are within acceptable tolerances, the containers is cleared for insertion, if the dimensions are outside the tolerances, the container is rejected from insertion, and for example a warning lamp or other signal may indicate the need to remove the container from the device. Camera 606 may also record an image of the container for various archival or other purposes.

FIG. 13 illustrates a storage container being handled by a temperature-controlled section of a container insertion device of the automated storage and retrieval system. The temperature-controlled section 620 may comprise refrigeration equipment 621 to circulate chilled air or maintain subzero temperatures depending on the types of goods stored in the container. The compartment 601 may comprise the entrance 608 provided with a door or an air curtain or a PVC curtain. The compartment 601 may also be provided with several temperature sensors 622 that are distributed throughout the passage 602 to monitor and record temperatures of the storage container and the goods stored in the storage container throughout the passage 602.

Once the storage container 106 attains the predefined temperature required for the goods, signals may be sent to the control system 500 that the container is ready for insertion into the storage system.

On the other hand, if the temperature sensors 622 monitor that the temperature of the storage container 106 has not attained the desired temperature required for the goods, the control system 500 may instruct the refrigeration equipment 621 to adjust the temperature to the required temperature range based on the type of temperature-sensitive goods stored in the container 106.

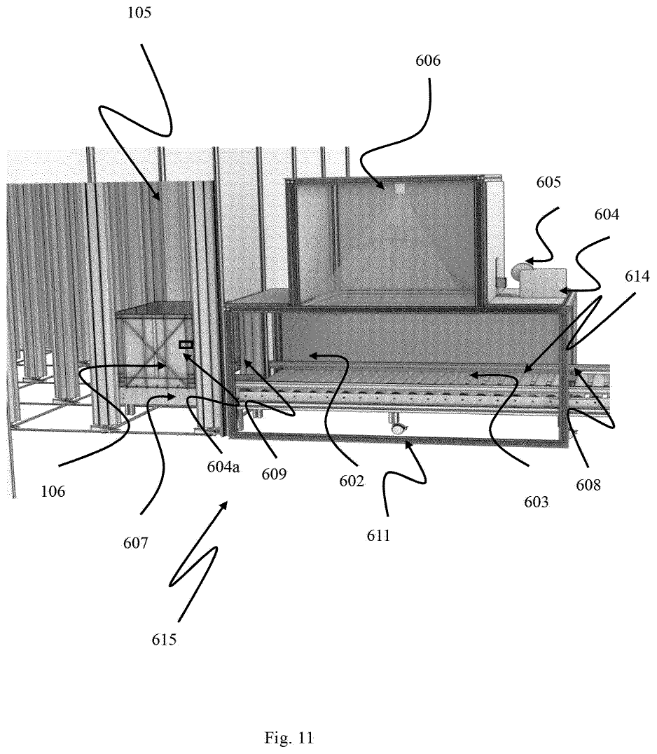

FIG. 10 depicts a storage container exiting the compartment from the container-preparation area and towards the support or platform 607 inside the storage column. In one aspect, the dimensions of the support or platform 607 are essentially same as or less than the size of a grid cell occupying the storage column, the platform having pushed aside hinged segments 619 from FIG. 12B, or other having passed through lateral opening 617.

As shown in FIG. 10, a storage container 106 that has been cleared for insertion arrives on the platform 607 and rests within the storage column 105 waiting to be picked up by a container handling vehicle that is instructed by the control unit 500 to pick up the storage container 106.

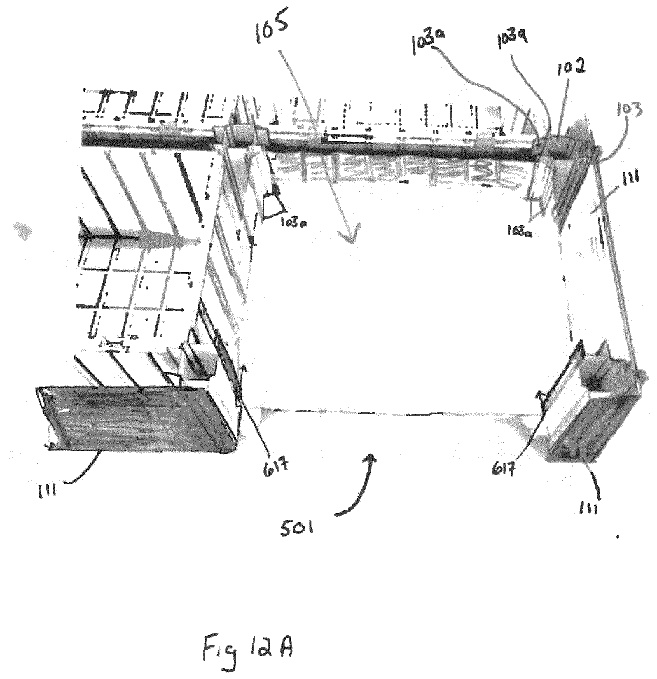

FIG. 11 shows a close up view of the storage column 105, with the storage container resting on the platform of the container insertion device 600 awaiting to be picked up by a container handling vehicle 201, 301, 401 of the storage system by means of its gripping and lifting devices.

Furthermore, the sequence of steps described above are repeated for each storage container 106 with temperature-sensitive goods contained within and that is inserted into the automated storage and retrieval system 1. Once all the storage containers 106 are inserted into the system, the control system may send instructions of completion of the container insertion process. The container insertion device 600 may then be removed from the storage column 105. The storage column 105 then may be used as an ordinary storage column 105 to store storage containers 106.

FIGS. 12A and 12 B—illustrate an empty storage column adjacent the opening in the wall from FIG. 6, showing different embodiments of an opening in the guide profiles permitting lateral insertion of a container into the storage column. In FIG. 12A the segments of faces of the guide profiles are removed, while in FIG. 12B hinged segments of faces of the guide profiles are shown. The container insertion device is then inserted to the empty column through the wall opening of FIGS. 12A and 12B.

FIG. 13 illustrates a temperature-controlled section of a container insertion device of the automated storage and retrieval system. As shown, a temperature control section 620 is provided as part of the container insertion device 600. The temperature-controlled section 620 may be integrated with passage/container handling area 602 of the insertion device. Temperature controlled section 620 comprises refrigeration equipment 621 for controlling the temperature of the containers. Examples of such refrigeration equipment include blast chiller, a freezer unit or other refrigeration equipment known in the art.

The refrigeration equipment 621 according to one aspect regulates the temperature to a predefined value established for the particular goods contained within the container, as the storage containers with the goods pass through the passage 602. The predefined temperature may be set by sending instructions from a control system 500 of the automated storage and retrieval system to the refrigeration equipment 621.

In an example, if the storage containers 106 to be inserted through the container insertion device 500 contain goods that needs to be maintained at a predetermined temperature range, for example from zero to 4 degrees Celsius, the control system 500 will instruct the refrigeration equipment to circulate chilled air inside the passage/container handling area 602 sufficient to attain the intended temperature range.

In another example, if the storage containers 106 to be inserted through the container insertion device 600 contain products that need to be maintained in a frozen state, the refrigeration equipment 621 may function as a freezer unit to maintain and circulate air in subzero temperature ranges and help attain or maintain the frozen condition of the goods.

Although not shown in the figure explicitly, it is to be understood that refrigeration equipment 621 comprises of essential components that are known in the field and will not be discussed in detail here.

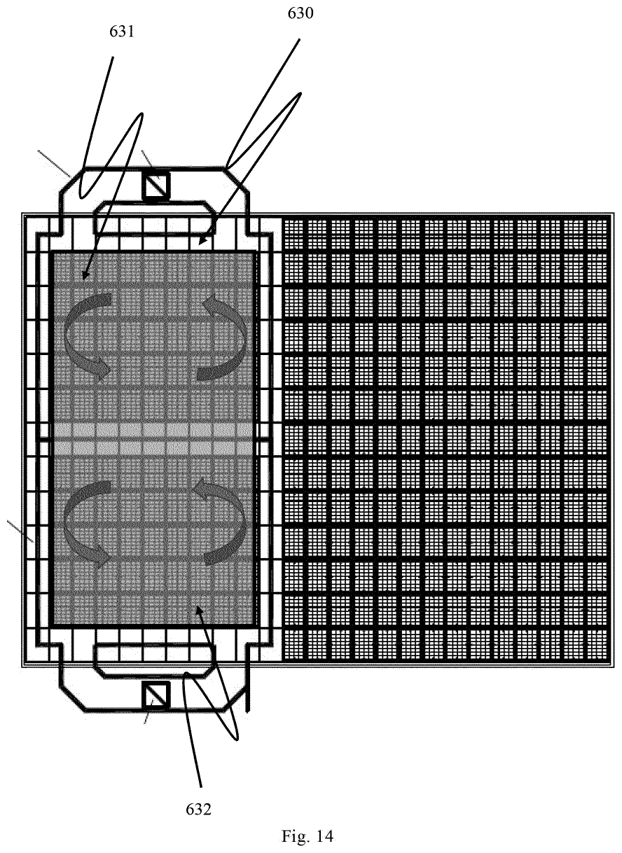

FIG. 14 illustrates a temperature-controlled section of an automated storage and retrieval system. The automated storage and retrieval system 1 are provided with a section that is temperature controlled section 630. The temperature-controlled section 630 may further be divided into a chilled storage section 631 and a frozen storage section 632. The temperatures in the chilled storage section may be maintained at any appropriate temperature range depending on the nature of the goods, for example the range may from 0 to 4 degrees and may be employed for example for the storage of fresh fruits and vegetables, dairy products, medical supplies etc. The temperatures in the frozen storage section will be at least below zero degrees Celsius and may for example be maintained below minus 18 degrees Celsius and used for storing sea food, meat, poultry, chemicals and medical supplies.

The storage containers 106 loaded with temperature-sensitive products when inserted into the container insertion device pass through the compartment 601 towards the passage 602 of the device. The control system 500 may send instructions to open the entrance door or curtain provided at the entrance of the compartment 601. The storage container 106 passes through the compartment to the passage 602. The temperature-controlled section 620 regulates the temperate inside the passage 602 and helps in attaining the required chilled or frozen temperatures for the storage containers 106 and the goods stored in the containers.

In an embodiment, the temperature-controlled section 620 may further comprise several temperature sensors 622 distributed inside the passage/container handling area 602). The temperature sensors 622 may be employed to check if the storage container that passes through the container insertion device attains the required temperatures based on the type of products contained in the storage containers.

In another aspect, the control system 500 may be in communication with the container insertion device and controls and monitors the functioning of the insertion device. For example, the control system 500 may monitor and record the temperature measured by the temperature sensors 622 in the passage 602. Based on the recorded temperature the control system may determine if the storage container has attained the required temperature based on its contents. If not, the control system 500 may send signals to the refrigeration equipment to adjust the temperature.

When the storage container 106 has attained the required temperature, the control system may send instructions to an (available) container handling vehicle to pick up the storage container from the support through the column of the storage system.

In an aspect, the conveyor 603 may comprises sections that are configured to move at different speeds. This allows controlling the movement of storage containers 106 as they pass through the passage 602 of the insertion device. In an example, a first container may contain frozen goods and require freezing temperature ranges. A subsequent container may contain chilled goods such as milk and thus the temperature of the temperature-controlled section will need to be regulated before the second container can pass through the passage. Thus, the second container may be passed through a slow-moving section of the conveyor to allow waiting time before the temperature of the temperature-controlled section is regulated by the control system 500.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

### Prior Art (FIGS. 1-4)

1 Prior art automated storage and retrieval system
100 Framework structure
102 Upright members of framework structure
104 Storage grid
103 Guide profile
103a Guide profile face
105 Storage column
106 Storage container
106′ Particular position of storage container
107 Stack
108 Rail system
110 Parallel rails in first direction (X)
111 Wall
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction
600 Bin/storage container insertion device
601 Compartment
602 Passage/storage container handling area
603 Conveyors
604 Labelling device
604a Label
605 ID Scanner
606 Dimension scanning device
607 Platform
608 Entrance
609 exit
610 ID tag
611 Wheels
613 Floor
614 Rear part
615 Forward part
617 Lateral opening in guide profile
619 Hinged segment
620 Temperature-controlled section of the container insertion device
621 Refrigeration equipment
622 Temperature sensor(s)
630 Temperature-controlled section of the automated storage and retrieval system
631 Chilled storage section
632 Cold storage section

1-19. (canceled)

20. A container insertion device for inserting storage containers containing temperature-sensitive goods laterally into a column of a storage volume of an automated storage and retrieval system, the device comprising:
a compartment that has an entrance and an exit, and a passage for conveying storage containers between the entrance and the exit, wherein the compartment comprises a temperature controlled section comprising refrigeration equipment for reducing the temperature of the container and/or contents of the container,
a conveyor arranged for transporting storage containers through the passage from a rear part of the insertion device to a forward part of the container insertion device,
a support extending from the exit of the compartment, the support being arranged to receive and support a storage container, wherein the support is dimensioned for lateral insertion into the storage column and thereby support a storage container within the storage column for retrieval by a container-handling vehicle of the system, and
one or more of a label affixing device for affixing an identification label to a container, an ID scanning device for scanning an identification label, and a dimension scanning device arranged to measure the physical dimensions of the container, the one or more of said devices being in electronic communication with a control system of the storage and retrieval system.

21. The device in accordance with claim 20, wherein the support of the device is arranged to be inserted through a lateral opening in the storage column, the lateral opening dimensioned to permit lateral insertion of a storage container.

22. The device in accordance with claim 20, wherein the device further comprises a set of wheels mounted on the underside of the device.

23. The device in accordance with claim 20, wherein the refrigeration equipment is a blast chiller and/or freezer.

24. The device in accordance with claim 20, wherein the conveyor further comprises sections that are configured to move at different speeds so as to allow waiting times in-between the storage containers that require different temperatures.

25. The device in accordance with claim 20, wherein the dimension scanning device is a camera or a laser scanning device or a measuring device that is capable of measuring the dimensions of the storage container.

26. The device in accordance with claim 20, wherein the support is one of: a platform, a supporting rail that has essentially the same lateral dimensions as the storage container.

27. The device in accordance with claim 20, wherein the support is configured to slide laterally into the storage column by pressing aside movable segments of corner guide profiles arranged on upright members defining the storage column.

28. The device in accordance with claim 20, wherein the temperature-controlled section further comprises temperature sensors to measure the temperature of the goods within the containers and/or of the passage.

29. An automated storage and retrieval system, comprising a framework structure forming a storage grid, the framework structure comprising:
a rail system arranged at an upper level of the framework structure, the rail system comprising a first set of parallel rails arranged in a horizontal plane and extending in a first direction, and a second set of parallel rails arranged in the horizontal plane and extending in a second direction which is orthogonal to the first direction, which first and second sets of rails form a grid pattern in the horizontal plane comprising a plurality of adjacent grid cells, and the storage grid defining a plurality of columns for use as storage columns, each storage column being arranged to store a respective stack of storage containers, wherein the storage columns are located beneath the rail system and wherein each storage column is located vertically below a respective grid cell;
a plurality of container handling vehicles that operate on the rail system for storing and retrieving storage containers to and from storage columns,
a control system configured for interacting with the system components and sending operating instructions to the plurality of container handling vehicles and other system components, the automated storage and retrieval system comprising:
a lateral opening in a side of the framework structure of the automated storage and retrieval system sized to allow a storage container to be inserted into a column of the system; and
a device for inserting storage containers through the lateral opening into the storage columns according to claim 20, for subsequent retrieval by container handling vehicles.

30. The automated storage and retrieval system as in claim 29, wherein the lateral opening comprises removed segments of faces of corner guide profiles affixed to upright members defining the storage column.

31. The automated storage and retrieval system as in claim 29, wherein the lateral opening comprises hinged segments of faces of corner guide profiles affixed to upright members defining the storage column.

32. The automated storage and retrieval system as in claim 29, wherein the control system is configured to send instructions to the refrigeration equipment to maintain a temperature range in temperature controlled section based upon the type of goods contained within containers to be inserted by the insertion device.

33. A method for inserting storage containers containing temperature-sensitive goods into a temperature-controlled section of an automated storage and retrieval system, the method comprising the steps of:
providing an opening in a side of the automated storage and retrieval system, the opening being dimensioned to permit the lateral insertion of a storage container into a column within a framework structure of the automated storage and retrieval system,
providing a container insertion device according to claim 20,
inserting the support of the insertion device through the opening to the column such that the support extends into the column,
placing a storage container containing temperature-sensitive goods on the conveyor,
operating the refrigeration equipment to establish a desired temperature within temperature-controlled section, the temperature based upon the nature of the goods within the container,
using the conveyor and transporting the storage container through the passage and through temperature controlled section towards the exit of the compartment of the device, the container remaining within temperature controlled section for a sufficient amount of time for the goods to achieve or maintain a desired temperature,
affixing an identification label to the storage container,
communicating identification information contained in the label and the nature of goods to a control system,
measuring the physical dimensions of the storage container using a dimension scanning device, and comparing the dimensions with predefined measurement tolerances,
using the conveyer to transport the storage container though the passage towards the exit of the compartment, and cooling the container and/or its contents as the container passes through the compartment,
using the conveyer to transport the container onto the support within the storage column, and
using a container handling vehicle of the automated storage and retrieval system to pick up the storage container from the support within the column, and place the container in a temperature controlled section of the storage system.

34. The method for inserting storage containers as in claim 33, wherein the method further comprises using the conveyer to transport subsequent storage containers, in sequence, onto the support for retrieval by a container handling vehicle.

35. The method for inserting storage containers as in claim 33, wherein the method further comprises sending instructions to the container handling vehicle to pick up the storage container through a control system in communication with the vehicle.

36. The method for inserting storage containers as in claim 33, wherein the temperature-controlled section of the automated storage and retrieval system further comprises at least: a chilled section and a frozen section.

37. A computer program product for performing the method of claims 34, wherein the product comprises:
a controller in communication with the control system and configured to monitor if the temperature of the storage container has reached the target temperature as the container passes through the refrigerated equipment of the container insertion device;
a memory unit with a database for storing the monitored temperature of the storage container,
the controller sending instructions to the control system that the storage container has attained the target temperature,
the control system sending instructions to a container handling vehicle to pick up the storage container from a support within the column, and place the container in a temperature controlled section of the storage system.

38. A computer program product in accordance with claim 37, wherein the controller monitors the temperature of the storage container by employing temperature sensors located in the compartment of the temperature-controlled section of the container insertion device according to claim 20.
